(19) United States
(12) Patent Application Publication
(10) Pub. No.: US 2005/0013546 A1
(43) Pub. Date: Jan. 20, 2005

(54) Highly reliable optical waveguide device

(76) Inventors: Masahiro Nakamura, Kanagawa (JP); Yoshihiro Takahashi, Kanagawa (JP); Kozo Kiyotake, Kanagawa (JP); Tohru Takahashi, Kanagawa (JP); Kanji Shishido, Kanagawa (JP)

Correspondence Address: MANELLI DENISON & SELTER, 2000 M STREET NW SUITE 700, WASHINGTON, DC, 20036-3307, US

(21) Appl. No.: 10/878,511

(22) Filed: Jun. 29, 2004

(30) Foreign Application Priority Data
Jul. 4, 2003 (JP) JP2003-270864

(51) Int. Cl. G02B 6/30

(52) U.S. Cl. 385/49

(57) ABSTRACT

An optical waveguide device 1 having optical fiber arrays 3a and 3b and a waveguide chip 2 connected to each other. Insertion holes 6a and 6b are provided for optical fiber holding members 5a and 5b comprising quartz glass or the like. Optical fiber cores of the optical fiber arrays 3a and 3b are inserted into the insertion holes 6a and 6b and are fixed with an adhesive material. Parts of covering optical fibers 4a and 4b are also fixed to apertures of the optical fiber holding members 5a and 5b with the adhesive material. According to the present invention, the optical fiber cores do not move inside the optical fiber arrays 3a and 3b in high-temperature or high-humidity environments. Accordingly, the use of the optical fiber arrays combined with the waveguide chip 2 provides a highly reliable optical waveguide device excellent in mechanical characteristics and transmission characteristics.

### BACKGROUND OF THE INVENTION

1. Field of the Invention

The present invention relates to an optical waveguide device that is composed of an optical array and waveguide chip, such as a waveguide splitter, an optical switch, or a variable optical attenuator.

2. Description of the Related Art

In recent years, the use of high-speed Internet is rapidly spreading through homes since the FTTH (Fiber To The Home) plan has taken effect. In such situation, it is necessary to further enrich functions of the entire optical communication network. The optical communication network requires an optical waveguide device that is highly reliable and can be miniaturized at reduced costs.

It is important to increase the reliability of optical waveguide devices so as to stabilize operation characteristics of the optical communication network especially in high-temperature or highly humid environments.

An optical waveguide device includes a waveguide chip such as a waveguide splitter, an optical switch, or a variable optical attenuator. During use, the optical waveguide device is connected to an optical fiber array comprising a plurality of parallel disposed optical fibers.

Each optical fiber is disposed on the optical fiber array so as to be precisely centered on the waveguide chip. A highly precise multi-core alignment technology is required to dispose optical fibers on the optical fiber array.

Conventional optical fiber arrays are manufactured as follows (Jpn. Pat. Appln. Laid-Open Publication No. 2002-171657).

1. A plurality of V-grooves are provided on a substrate composed of quartz glass or the like. Each V-groove is accurately aligned to the waveguide chip.

2. bare optical fibers are placed in these V-grooves.

3. The bare optical fibers are covered with a cover member composed of quartz glass or the like.

4. An adhesive material is used to fix the bare optical fibers, the V-grooved substrate, and the cover member to each other.

The above-mentioned prior art has the following problems to be solved.

When installed in an outdoor closure, for example, the optical waveguide device is often subject to severe environments. The optical waveguide device needs to indicate stable characteristics against high temperature or humidity.

When the optical waveguide device is exposed to high temperature or humidity, the adhesive material used expands, shrinks, or deteriorates. As a result, the cover member is detached from the V-grooved substrate for the optical fiber array. In addition, the optical fiber array is sometimes detached from the waveguide chip.

As conventional improvements, an attempt has been made to optimize types and curing conditions of adhesive materials to increase the reliability or optimize shapes and thicknesses of quartz glass covers as cover members. Sealing materials have been used for tight seal so as to be resistant against highly humid environments. An improvement technology is disclosed to make the cover member hardly peel off by slanting a bonded surface between the optical fiber array and the waveguide chip against an optical fiber axis (e.g., see Jpn. Pat. Appln. Laid-Open Publication No. 7-209547).

However, it is difficult to slantwise polish bonded surfaces of the optical fiber array and the waveguide chip at an accurate angle, increasing work loads (Jpn. Pat. Appln. Laid-Open Publication No. 7-209547).

On the other hand, ultraviolet-curing adhesive materials are used for optical fiber arrays. Such adhesive materials are characterized by a low glass transition point of approximately 100° C., not excellent in the resistance to high-temperature environments. What is worse, adhesion properties deteriorate at lower temperatures in a high-temperature and high-humidity environment.

The above-mentioned technologies are all dedicated to preventing the movement of optical fibers, V-grooves, and cover members due to expansion, contraction, or deterioration of the adhesive materials for optical fiber arrays in high-temperature or highly humid environments. Accordingly, the conventional technologies are insufficient for achieving the purpose of prevention against degradation of mechanical characteristics or transmission characteristics of optical waveguide devices.

The present invention has been made in consideration of the foregoing. It is therefore an object of the present invention to provide an optical waveguide device which, if used in high-temperature or highly humid environments, can maintain stable mechanical characteristics or transmission characteristics without moving optical fibers constituting an optical fiber array from specified positions.

### SUMMARY OF THE INVENTION

To solve the conventional problems as mentioned above, the present invention provides a highly reliable optical waveguide device comprising an optical fiber array and a waveguide chip connected to each other, in which the optical fiber array comprises an optical fiber and an optical fiber holding member, the optical fiber comprises one or more optical fiber cores, and the optical fiber core is inserted into an optical fiber insertion hole of the optical fiber holding member.

According to the present invention, there is provided the highly reliable optical waveguide device, in which the optical fiber holding member is provided with as many optical fiber insertion holes as the one or more optical fiber cores.

According to one aspect of the present invention, there is provided the highly reliable optical waveguide device, in which the optical fiber core is bare glass and is inserted into an optical fiber insertion hole of the optical fiber holding member so as to be fixed with an adhesive material

According to another aspect of the present invention, there is provided the highly reliable optical waveguide device, in which the optical fiber holding member comprises quartz glass.

According to yet another aspect of the present invention, there is provided the highly reliable optical waveguide device, in which the waveguide chip is a waveguide splitter, an optical switch, or a variable optical attenuator.

According to still yet another aspect of the present invention, there is provided the highly reliable optical waveguide device, in which an bare glass portion of the optical fiber core is fixed, with an adhesive material, to an inside of an aperture at an entry of the optical fiber insertion hole of the optical fiber holding member.

According to yet still another aspect of the present invention, there is provided the highly reliable optical waveguide device, in which an aperture at an entry of the optical fiber insertion hole has a larger diameter than that of the optical fiber insertion hole and is sized to insert a covering portion of the optical fiber.

According to still yet another aspect of the present invention, there is provided the highly reliable optical waveguide device, in which the optical fiber holding member comprises quartz glass.

According to yet still another aspect of the present invention, there is provided the highly reliable optical waveguide device, in which the waveguide chip is a waveguide splitter, an optical switch, or a variable optical attenuator.

### BRIEF DESCRIPTION OF THE DRAWINGS

The above and other objects, advantages and features of the present invention will be more apparent from the following description taken in conjunction with the accompanying drawings in which:

FIG. 1 is a plan view of an optical waveguide device according to the present invention;

FIG. 2 is a perspective view of the an optical fiber array used for the optical waveguide device according to the present invention;

FIG. 3 is a partial vertical sectional view showing an embodiment of the optical fiber array;

FIG. 4 is a side view of the optical fiber array shown in FIG. 3;

FIG. 5 is a cross sectional view taken along lines C-C of an optical fiber in FIG. 3;

FIG. 6 is a cross sectional view taken along lines B-B of an optical fiber holding member in FIG. 3;

FIG. 7 is a cross sectional view taken along lines A-A of the optical fiber holding member in FIG. 3;

FIG. 8 is a partial vertical sectional view showing another embodiment of the optical fiber array;

FIG. 9 is a cross sectional view taken along lines F-F of the optical fiber in FIG. 8;

FIG. 10 is a cross sectional view taken along lines E-E of the optical fiber holding member in FIG. 8; and

FIG. 11 is a cross sectional view taken along lines D-D of the optical fiber holding member in FIG. 8.

### DETAILED DESCRIPTION OF THE PREFERRED EMBODIMENTS

Best modes of carrying out the present invention will be described in further detail using various embodiments with references to the accompanying drawings.

Next, details explain the embodiments regarding implementation aspects.

FIG. 1 is a plan view of an optical waveguide device according to the present invention.

In FIG. 1, an optical waveguide device 1 according to the present invention comprises a waveguide chip and an optical fiber array connected to each other. According to the embodiment, an optical fiber array 3a and an optical fiber array 3b are connected to both ends of a waveguide chip 2. The optical fiber array 3a comprises an optical fiber 4a and an optical fiber holding member 5a. The optical fiber array 3b comprises an optical fiber 4b and an optical fiber holding member 5b. The waveguide chip 2 comprises a waveguide splitter, an optical switch, or a variable optical attenuator, for example. Any of the waveguide chips is selected for use in accordance with the intended use of the optical waveguide device.

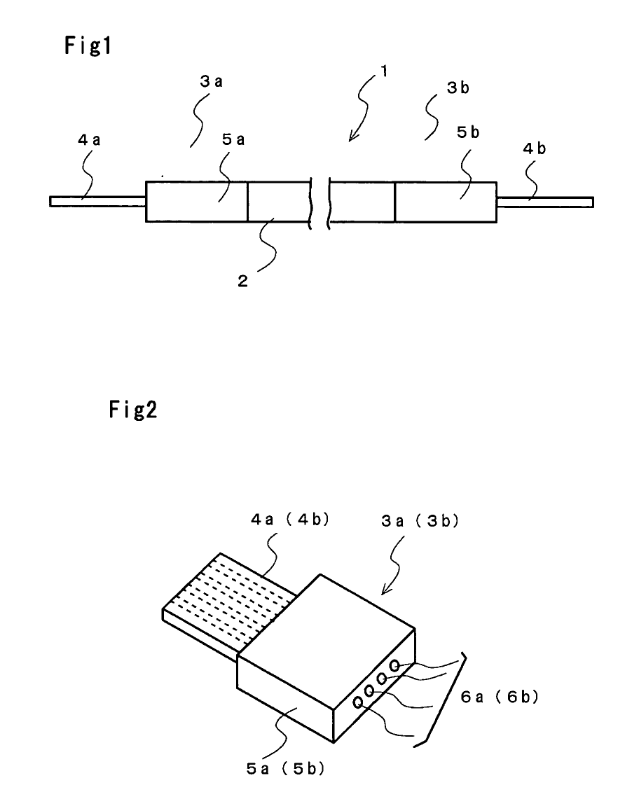

FIG. 2 is a perspective view showing an embodiment of the optical fiber array.

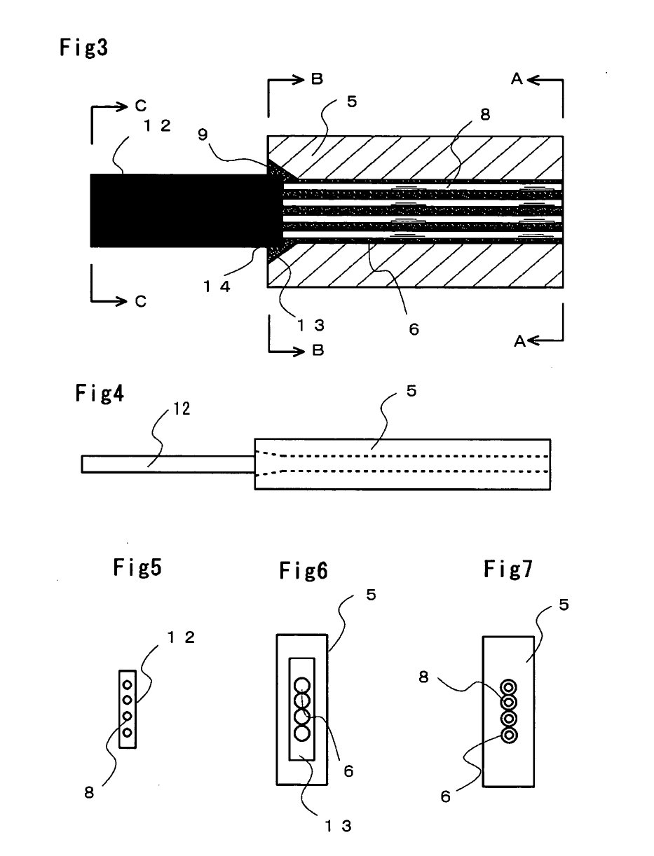

As shown in FIG. 2, the optical fiber array 3a comprises the optical fiber 4a and the optical fiber holding member 5a composed of quartz glass. The optical fiber 4a has one or more optical fiber cores. The optical fiber core is inserted into an optical fiber insertion hole 6a of the optical fiber holding member 5a. The optical fiber core is fixed in the optical fiber insertion hole 6a using an adhesive material. The structure thereof will be described in detail with reference to FIG. 3 or later. The optical fiber arrays 3a and 3b may have completely the same configuration. The optical fibers 4a and 4b have the same configuration. The optical fiber holding members 5a and 5b have the same configuration. The insertion holes 6a and 6b have the same configuration.

Let us assume that the waveguide chip 2 is composed of a 1×N waveguide splitter, for example. One optical fiber core receives an optical signal that is then output to N optical fiber cores. Therefore, one optical fiber array 3a is provided with an optical fiber having one optical fiber core. The other optical fiber array 3b is provided with an optical fiber having N optical fiber cores. There is provided one insertion hole 6a for the optical fiber holding member 5a of the optical fiber array 3a. There are provided N insertion holes 6a for the optical fiber holding member 5b of the optical fiber array 3b.

FIG. 3 is a partial vertical sectional view showing an embodiment of the optical fiber array.

FIG. 4 is a side view of the optical fiber array shown in FIG. 3.

FIG. 5 is a cross sectional view taken along lines C-C of an optical fiber in FIG. 3.

FIG. 6 is a cross sectional view taken along lines B-B of an optical fiber holding member in FIG. 3.

FIG. 7 is a cross sectional view taken along lines A-A of the optical fiber holding member in FIG. 3.

The embodiment in FIG. 3 shows that the optical fiber 12 is composed of tape conductors. The optical fiber 12 comprises a plurality of optical fiber cores 8. In this example, there are provided four optical fiber cores 8. The optical fiber holding member 5 is provided with four insertion holes 6 for inserting the optical fiber cores 8. The optical fiber core 8 is bare glass fiber that appears after removing a covering of the optical fiber 12. The covering is a plastic coating of the optical fiber. The optical fiber holding member 5 further has an aperture 13 for inserting a covering portion 14 of the optical fiber 12. As shown in FIG. 3, the aperture 13 is provided at an entry of the insertion hole 6. The aperture 13 has a larger diameter than that of the insertion hole 6 and is sized to be capable of inserting the covering portion 14 of the optical fiber 12.

After removing the covering, the optical fiber core 8 is inserted into the insertion hole 6. The optical fiber core 8 is fixed in the insertion hole 6 with an adhesive material 9. The covering portion 14 of the optical fiber 12 is also inserted into the aperture 13 of the optical fiber holding member 5 and is fixed with the adhesive material 9.

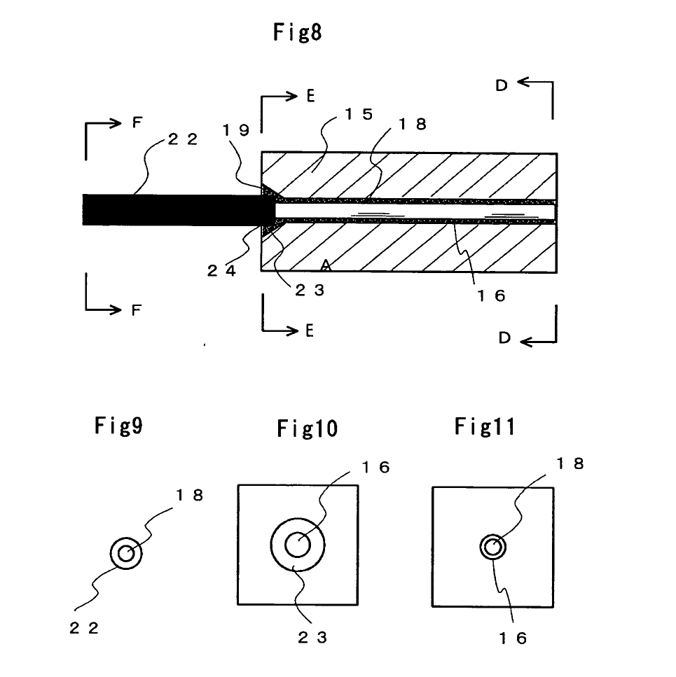

FIG. 8 is a partial vertical sectional view showing another embodiment of the optical fiber array.

FIG. 9 is a cross sectional view taken along lines F-F of the optical fiber in FIG. 8.

FIG. 10 is a cross sectional view taken along lines E-E of the optical fiber holding member in FIG. 8.

FIG. 11 is a cross sectional view taken along lines D-D of the optical fiber holding member in FIG. 8.

FIG. 9 shows an optical fiber 22 having one optical fiber core 18. First, a covering is removed from the optical fiber 22 to expose the bare optical fiber core 18. The optical fiber core 18 is inserted into an optical fiber insertion hole 16 of an optical fiber holding member 15 and is fixed with an adhesive material. The optical fiber holding member 15 has an aperture 23 for inserting a covering portion 24 of the optical fiber 22. The aperture 23 has a larger diameter than that of the insertion hole 16 and is sized to be capable of inserting the covering portion 24 of the optical fiber 22. The covering portion 24 of the optical fiber 22 is also fixed to the inside of the aperture 23 of the optical fiber holding member 15 with an adhesive material 19. This increases the strength per unit area.

We left the optical waveguide device according to the present invention in an atmosphere of temperature 121° C. and humidity 100% under 2 atm. for ten hours. Then, we inspected external changes and transmission characteristics. We found no special external changes or no degradation of the transmission characteristics. We also left a conventional optical waveguide device in the same atmosphere for ten hours. This optical waveguide device uses an optical fiber array comprising a conventionally structured V-grooved substrate and a cover member. As a result, we found many air bubbles between the cover member and the V-grooved substrate. The cover member is peeled from the V-grooved substrate. Further, we left the optical waveguide device according to the present invention in an atmosphere of temperature 90° C. and humidity 99% under the ambient pressure for 270 hours. We found no special external changes or no degradation of the transmission characteristics.

Conventionally, the optical fiber array is composed of a plurality of members such as the V-grooved substrate and the cover member. On the other hand, the optical waveguide device according to the present invention is configured so that the optical fiber core is inserted into the optical fiber insertion hole 16 of the optical fiber holding member 15 and is fixed with the adhesive material. Accordingly, the optical fibers do not move in high-temperature or highly humid environments. Since the optical fiber holding member 15 comprises a uniform member such as quartz glass, it is possible to prevent mechanical characteristics or transmission characteristics from degrading.

The present invention can be applied to the highly reliable optical waveguide device in high-temperature and highly humid environments.

1. A highly reliable optical waveguide device comprising an optical fiber array and a waveguide chip connected to each other, wherein
said optical fiber array comprises an optical fiber and an optical fiber holding member,
said optical fiber comprises one or more optical fiber cores, and
said optical fiber core is inserted into an optical fiber insertion hole of said optical fiber holding member.

2. The highly reliable optical waveguide device according to claim 1,
wherein said optical fiber holding member is provided with as many optical fiber insertion holes as said one or more optical fiber cores.

3. The highly reliable optical waveguide device according to claim 2,
wherein said optical fiber core is bare glass and is inserted into an optical fiber insertion hole of said optical fiber holding member so as to be fixed with an adhesive material

4. The highly reliable optical waveguide device according to claim 3,
wherein said optical fiber holding member comprises quartz glass.

5. The highly reliable optical waveguide device according to claim 3,
wherein said waveguide chip is a waveguide splitter, an optical switch, or a variable optical attenuator.

6. The highly reliable optical waveguide device according to claim 3,
wherein an bare glass portion of said optical fiber core is fixed, with an adhesive material, to an inside of an aperture at an entry of said optical fiber insertion hole of said optical fiber holding member.

7. The highly reliable optical waveguide device according to claim 6,
wherein an aperture at an entry of said optical fiber insertion hole has a larger diameter than that of said optical fiber insertion hole and is sized to insert a covering portion of said optical fiber.

8. The highly reliable optical waveguide device according to claim 7,
wherein said optical fiber holding member comprises quartz glass.

9. The highly reliable optical waveguide device according to claim 7,
wherein said waveguide chip is a waveguide splitter, an optical switch, or a variable optical attenuator.
